(19) United States
(12) Patent Application Publication
(10) Pub. No.: US 2013/0031010 A1
(43) Pub. Date: Jan. 31, 2013

(54) METHOD & APPARATUS FOR CONFIGURING A REMOTE PRODUCT MANAGEMENT SERVICE

(71) Applicant: TIMOTHY D. ROOT, Nashua, NH (US)

(72) Inventor: TIMOTHY D. ROOT, Nashua, NH (US)

(73) Assignee: VGO Communications, Inc., Nashua, NH (US)

(21) Appl. No.: 13/192,794

(22) Filed: Jul. 28, 2011

(51) Int. Cl. G06Q 30/00

(52) U.S. Cl. 705/304

(57) ABSTRACT

A product source site, a VAR site and a customer site are connected to a communications network. A mobile communications device is sold by a VAR to the customer, and the VAR notifies the customer of a product origination code (POC) that is unique to the product source and to each VAR that sells products to the customer. The customer uses the POC to activate a software client that can be used to both control a product unit and to register the product unit with the remote product monitoring and management service. The remote product monitoring and management service can be configured to create a data base record that corresponds to the POC that can be used to store product operational information that is gather from the customers product by the remote product monitoring and management service.

### CROSS REFERENCE TO RELATED APPLICATIONS

This application claims the benefit under 35 U.S.C. §119(e) of U.S. Provisional Patent Application Ser. No. 61/368,280 entitled “METHOD OF DEPLOYING A PRODUCT UNIT IN A NETWORK”, filed Jul. 28, 2010, the entire contents of which is incorporated by reference.

### FIELD OF INVENTION

The present disclosure generally relates to wide area communications networks and specifically to activating and remotely managing a communications device in the network.

### BACKGROUND

A product source or product manufacturer typically attaches a unique serial number to each product unit that they manufacture in order to identify the product unit for post sales service and possibly for other purposes. Typically, a customer that purchases a product can register it with the manufacturer in order to obtain post sales information such as product updates and access to product service, and the product source can associate a particular range of product unit serial numbers with a particular version of the product. Products can either be sold by the manufacturer directly to an end user/customer or they can be sold indirectly by the manufacturer to a customer via an intermediary, such as value added reseller (VAR) which can sell the product to the customer.

At the time a customer receives a product that is designed to be connected to a communications network, and depending upon the type of product purchased, there may be an opportunity for the customer to register their product with the manufacturer in order to receive product management services, such as software updates or other notices from the manufacturer. Also, it may be desirable that the product source is able to monitor certain operational information with respect to a product unit located at a customer's site. In this case, the customer may be able to register the product in a manner that allows the product source to periodically gather operational information from the product unit, and store this information for immediate or for later use in order to detect faulty product operation, product use schedules, or other product operational information. Typically, the product source restricts access in the product operational information that it collects to an administrator or technicians working for the product source entity.

### BRIEF DESCRIPTION OF THE DRAWINGS

The description of the embodiments can be more fully appreciated with reference to the accompanying Figures listed below.

FIG. 1 is a diagram of a communications network 10 showing a product source, a VAR and a customer site connected to the network.

FIG. 2 is a diagram of functional elements that can be included at a product source site location.

FIG. 3 is a diagram of functional elements that can be included at a VAR site location.

FIG. 4 is a diagram of the functional blocks comprising a source site server.

FIG. 4 is a diagram of functional elements that can be included at a customer site location.

FIG. 5 is a diagram illustrating a process that can be followed to configure one embodiment of a remote product management service.

FIG. 6 is a diagram illustrating a process that can be followed to configure another embodiment of a remote product management service.

### DETAILED DESCRIPTION

In order to permit secure and privileged access by a customer or intermediary (such as a VAR) to operational information about the customers product that is collected and stored by a product source, such as the manufacturer of a product, it was discovered that a code (product origination code), unique to and associated with the source of the product, can be provided to the customer which can be used to initiate the configuration of a secure, remote product management/monitoring service running on a server under the control of the product source. Operational information collected by the secure, remote product management service from the customer's product is stored on the server in a separate file indexed according to the product origination code (POC) and is accessible only by the product source. Alternatively, the product source can grant the VAR access to customer product operational information for those product units that it sells to customer, and the customer can be granted permission to access product operational information corresponding to those product units it purchases from either the product source or the VAR. The term, “product source” is used herein to mean the manufacturer of a product or the entity responsible for the initial sale of one or more units of a product. The term “source of a product” is used herein to mean the entity that sells a product to a customer. In this context, the source of a product can be the product source or a VAR/intermediary, or some other entity that sells a product directly to a customer. The term “product origination code (POC)” is used herein to mean a code that is assigned by the product source to the entity that sells a product directly to a customer and which is unique to each of the entities that sells the product to a customer. In this context, a different POC is assigned to each VAR and the product source can also assign a unique POC to itself. Embodiments of the secure, remote product management service are described below with reference to the Figures.

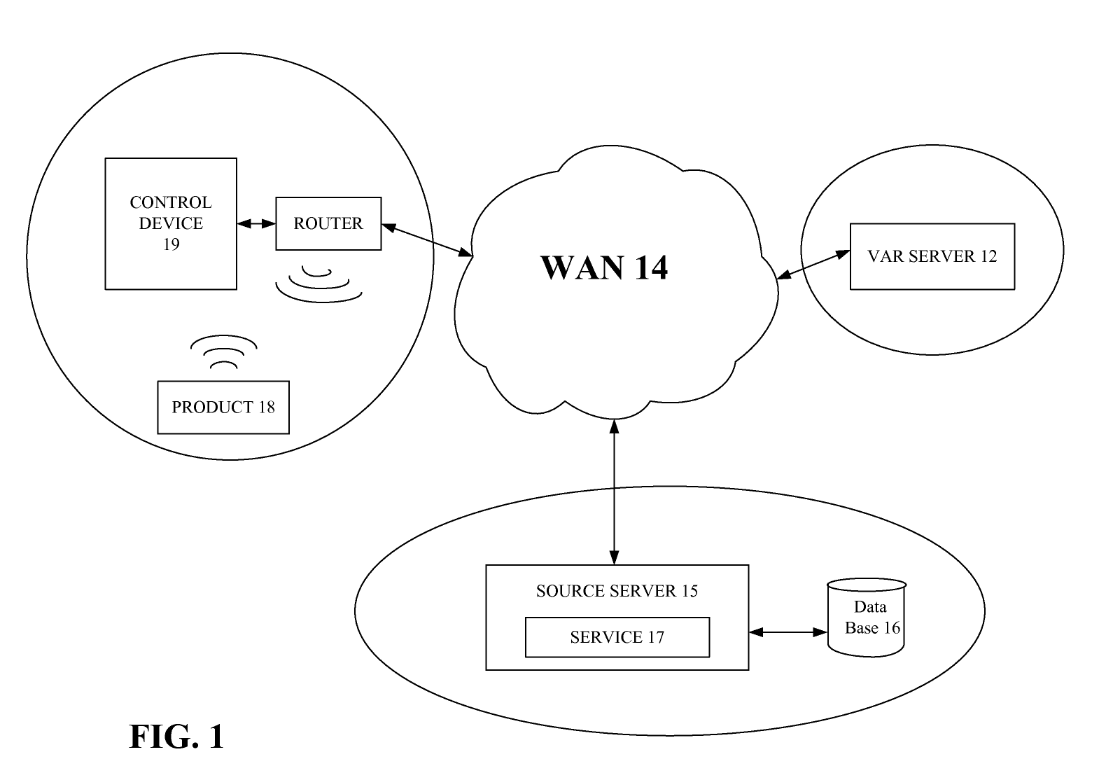

FIG. 1 is illustrative of a network 10 topology that includes functionality that is capable of supporting the operation of the secure, remote product management service 17, or simply the Service 17. In one embodiment, the network 10 is comprised of a wide area network 14 (WAN) that includes some number of interconnected communication devices (such as routers) that operate to receive packets of information from a source device and forward the information to a destination device. Attached to network 14 are shown a product source site 11, an intermediary product site 12 and a customer product site 13. The three sites can communicate with each other over the WAN 14, which is generally referred to as the Internet but can be a private network as well.

The source site 11 can be comprised of a computational device such as a server 15 that includes functionality to support the Service 17, storage to maintain a database 16 of customer product information, and an administrative function that can be generally used to manage the source site 11. The Service 17 generally operates to gather operational information from customer devices and to store this information in the data base 16 where is can be examined by the source site 11 administrator. Subject to one or more levels of permissions granted by the source site 11, the Service 17 can operate to allow intermediaries and customers to access product operational information stored in the data base 16. This product operational information can include, but is not limited to, such things as the operational status of a product (in use, not in use), information about failures relating to any of the functionality included on the product, to name only two things. The source site 11 is also generally configured to support an initial sales transaction of one or more products, such as a mobile robotic device to an intermediary, such as a VAR and/or directly to a customer.

The intermediary, or VAR site 12, in FIG. 1 is comprised of a VAR server that, among other things, includes software to support customer product sales and a software client that operates to access customer product operational information for those products it sells to its customers, and which can be used by the VAR, in conjunction with a proxy server running on the source site server 15, to perform certain product service procedures (such as update product software). Subject to permissions granted by the source 11, a VAR may or may not be able to use the software client to access a customer's product operational information stored in the data base 16.

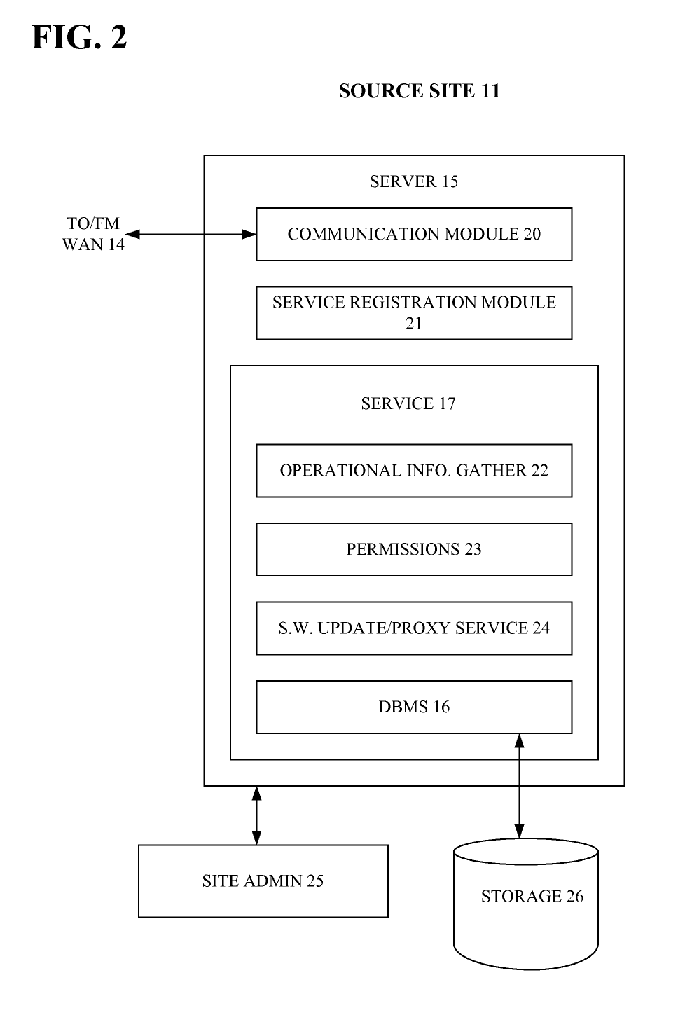

Continuing to refer to FIG. 1, the customer site 13 can include a wireless router that generally operates to support communications between the customer site 13 and the rest of the network 14. The customer site can also include a control device 19 and one or more product units 18. The product unit 18 can be a mobile, robotic device generally designed to serve as a communication platform and includes, among other things, audio and video communication functionality, environmental sensors such as temperature, IR, motion and light sensors. The control device 19 is comprised of a software client (not shown) which can be used by a customer to generally control the operation of the product 18, which in the preferred embodiment is a robotic device, and the client can be used to interact with the source site 11 to register individual product units purchased by the customer. According to one embodiment, the control device 19 uses a product origination code (POC) to activate the software client so that it can be used to control the product and to register a customer's product with the Service 17. The customer's software client can only be activated/initialized with a product origination code (POC) that is provided to the customer by either the source site 11 or the VAR site 12. The process for activating the customer/VAR software client will be described later with reference to FIG. 2. It should be understood that although the control device 19 is shown associated with a particular wireless router at the customer's site 13, the control device 19 can be portable and physically removed from the customers site and connected to another location in the WAN 14.

FIG. 2 is a block diagram showing functional elements that comprise the source site 11. Generally, the source site 11 includes the server 15 described earlier with reference to FIG. 1, an associated storage device 26 (disk or some other form of hardware storage) that is used to maintain customer product operational information and an administrative function 25 that can be used by a site administrator to provision and configure the various devices associated with the source site 11. Among other things, the server 15 can include a communication module 21 (web browser for instance) that serves to establish a communication session between the source site 11 and the customer's site 13 or the VAR's site 12 over the network 14. The server 15 can include a service registration module 21 which generally operates to receive requests from a VAR or customer to initialize a software client, issue certificates to trusted customers, and to process requests from customers to register one or more product units with the Service 17. The server 15 can also include functionality that provides the Service 17, which will be described shortly.

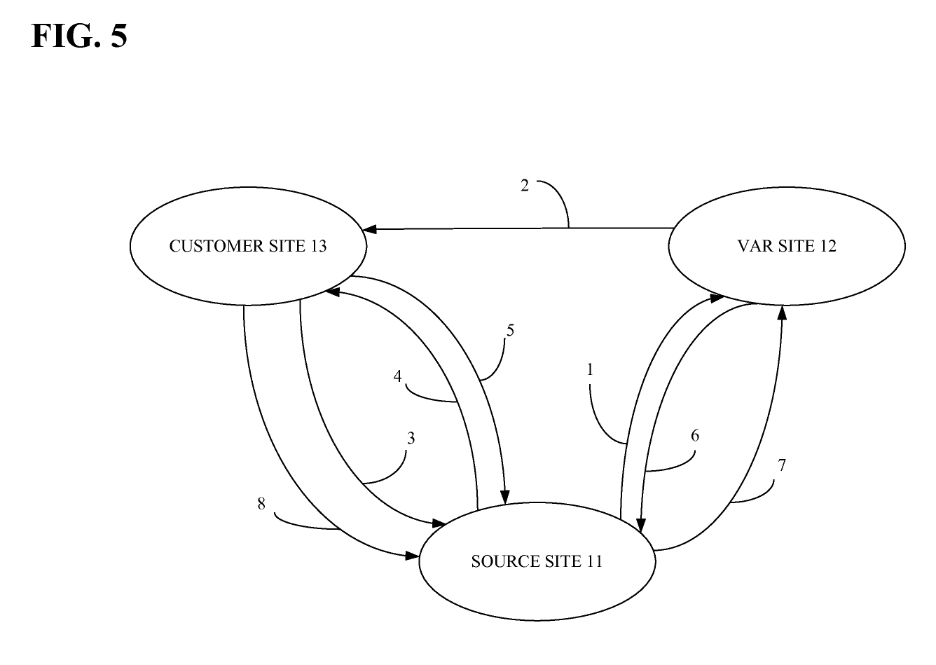

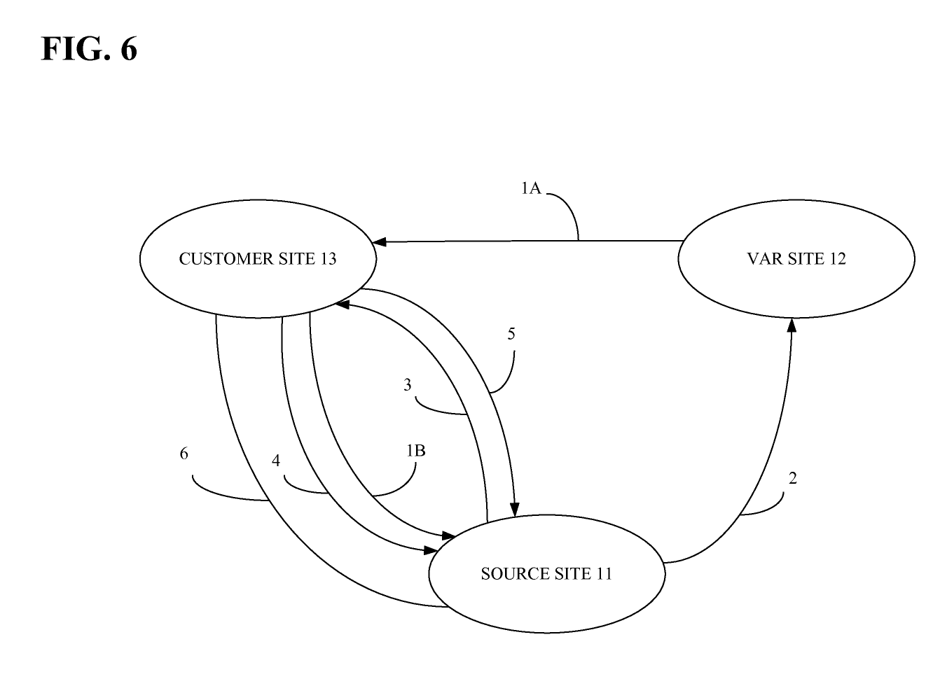

As alluded to above, the service registration module 21 of FIG. 2 processes requests from a customer or VAR to activate a software client at their respective sites. Such a request can be comprised of at least the product origination code (POC) which is supplied by the VAR or the source site with the product at the time of sale. As described earlier, the POC is unique to the source of the product, which can be either a product source, such as the manufacturer, or a product reseller, such as the VAR 12. During the process of initializing the customer client software, the product origination code (POC) is sent by the customer 13 to the service registration module 21 running on the source server 15. The registration module 21 can compare the POC received from the customer with POCs stored at the source site 11 to verify that the customer is allowed to activate the client software. If the registration module 21 verifies the customer POC, then it can issue and send a digital certificate to the customer (this functionality can be implemented in a certification authority) that is comprised of a public key and the identity of the customer. The digital certificate is stored on the customers server in association with the software client for use later during a product unit registration process which will be described later with reference to FIGS. 5 and 6. After receiving the digital certificate, the customer can become a trusted customer, from the perspective of the Service 17, and is granted permission to register individual product units with the Service 17 and may be granted permission to access product operational information stored at the source site 11. Subsequent to the customer's software client being activated, the customer can register a product with the Service 17 by sending a product registration request, that includes the unique product unit identifier (serial number for instance) and the digital certificate (public key) to the source server 15. The service registration module 21 running on the source server 15 receives this request, and determines that the public key corresponds to a private key stored on the source server. Based upon the public and private key correspondence, the source server 15 (registration module 21) determines that the request is received from a trusted customer, and instructs the Service 17 to configure the storage device 26 with a file used to store the customer product operational information. More specifically, the Service 17 can include a data base management system (DBMS) 16 which generally operates to configure the storage device 26 with files relating to operational information retrieved from customer products and which can be used by the source, customers, and VARs to access the operational information. Each separate file can be formatted to include operational information from one or more customer product units that were sold to the customer by a single source of the product (product source or VAR for instance).

Continuing to refer to FIG. 2, the Service 17 functionality running in conjunction with the server 15 also includes a permissions module 23 and a software update module/proxy server 24. The permissions module 23 receives and may grant requests from either or both of a customer and a VAR for permission to access different types of customer product operational information securely stored at the source site 11. Multiple different levels of permission can be defined each of which allow a customer or VAR access to specified product operational information. So, for instance, a VAR may need to know the version of software a customer's product is running in order to schedule software updates, or a customer may want to know how often and what time of day their units are being used. The software update module 24 can store the latest versions of software/firmware that the product uses during operation. This software can be operating software and/or applications software, for instance. Alternatively, the update module 24 can simple store a pointer to some location on the server 15 that stores a copy of the software.

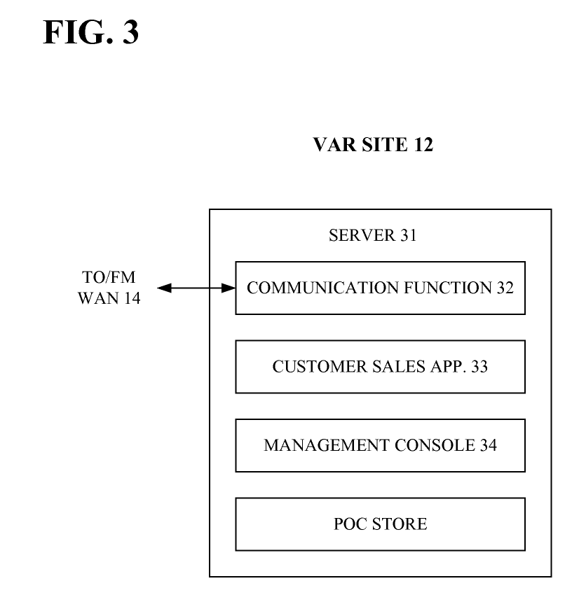

FIG. 3 is a block diagram showing functionality that can be included at a VAR site 12 to support the customer sales process and the after sale monitoring and service of customer products. A server 31 can include a communication application 32 that the VAR can use to request an account with the source site 11 and with which the VAR can access either the source site database 16 or to access the source site proxy server 24. The server 31 can also include a customer sales application 33 and a unit management console application 34 that is uses to display customer unit status information in a convenient format. Generally, the VAR operates as an independent sales representative for the product source to sell products and to perform certain after sales service with respect to the products it sells for the product source 11. Each VAR 12 receives a POC from the product source 11 that is unique to that VAR and which identifies that VAR as the seller of a product unit. The POC can be stored on the VARs server 31 and the VAR can notify their customers who purchase products of this unique VAR POC. Their customer only needs to be notified of the POC once, as it will not change as long as the customer continues to purchase products from the same VAR.

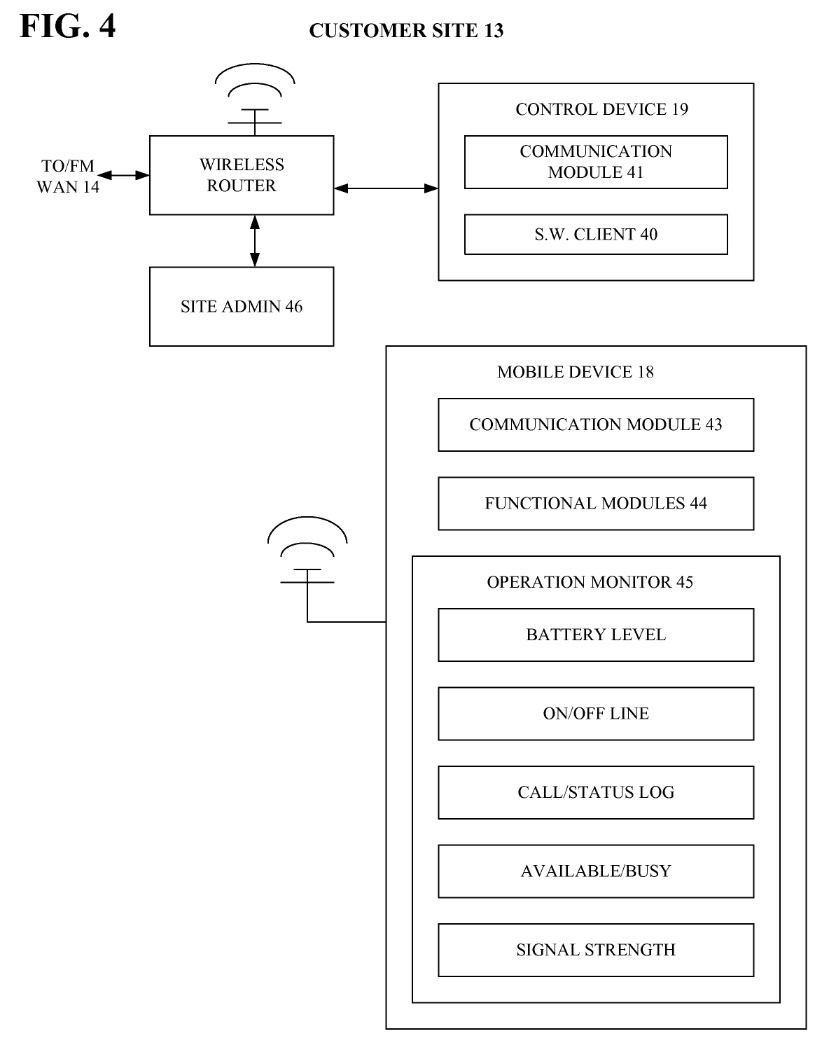

FIG. 4 represents equipment and functionality that can be included at the customer site 13 to support the operation and monitoring of one or more product units it purchases from a VAR or from the product source. In one embodiment, the product purchases can be a mobile robotic device. The customer site can include a wireless router or communications base station that is connected to the WAN 14 and the control device 19, both described earlier with reference to FIG. 1. The router operates as the interface between the devices located at the customers site and the network 14. The control device 19 is comprised of, among other things, a communication module 41 and a software client 40 as described earlier with reference to FIGS. 1 and 2. The robotic device 18 can include a communication module 43 to support wireless communication with the router 41, it can include a number of other applications and modules 44 directed to audio and video communication functionality and to the operation of the mobile robotic device 18 in general. The robotic device 18 can also include a device status monitor 45 that operates to periodically detect and store information relating to the operation of the robotic device. This operational information can include such things as the charge level of a battery in the device, whether the device is on-line or off-line, a log of call activity (how much time spend in call mode), the status of any error registers or other operational information stored in device registers, whether the device is currently available to enter into a communications session or if it is in an active session, wireless signal strength to name only a few.

After the customer purchases and receives a product unit and is notified by the source of the product of a POC, it can use the POC, it can use the POC to activate a software client that the customer can use to control the operation of the product unit. Activation of the software client can be initiated in a request sent by the customer to the product source that includes the POC. The customer software client can be downloaded if the customer does not already have a copy, and the control device 19 can receive a digital certificate from the registration module 21 running on the source site server 15 in response to the request. By activating the customer software client such that that digital certificate is associated with the client, the source site 11 is able to confirm that the customer is a trusted customer every time the customer uses the client to communicate with the product source. Each message that a trust customer sends to the source site server 15 includes a copy of the digital certificate (public key) which the Service 17 located at the source site 11 matches to a private key to verify that the customer is a trusted customer. One such message sent to the source site 11 by the customer can be a message to register an initial or new product unit with the Service 17. Such a message from the customer also includes the network address of the product unit, and the Service 17 (specifically the operational information gathering module 22 running in association with the Service 17) located at the source site 11 can use this network address to periodically retrieve operational information from the customer's product unit status monitor 45. Or, alternatively, the monitor 45 can include a function (not shown) that periodically sends operational status information to the Service 17. In operation, the customer uses the control device 19 to control the operation of the device 18, which can include movement control, initiating and terminating audio and/or video communication sessions, or any of the other functionality included in the device.

With continued reference to FIG. 4, and in one embodiment, the customer site 13 includes an administrative or information technology function 46 that can be granted permission by the source site 11 to access certain the customer's product operational information located in storage 26 at the source site 11. As described earlier, there can be multiple levels of permission granted to the customer depending upon a particular customers needs or other factors. The grant of permission by the source site 11 to a customer for access to their product operational information can be also include the assignment of a password which allows the customer to access a particular type or a range of operational information stored in the customer product operational information files at the source site 11. A process that can be followed to configure an embodiment of the Service 17 is described below with reference to FIG. 5.

FIG. 5 is a diagram showing the steps that can be followed by each of three sites (source, VAR and customer) to configure a remote customer product monitoring service, such as the Service 17 running on a source site server, such as the server 15 located at source site 11. FIG. 5 illustrates the transactions that can occur between the three sites in the course of selling a unit, reselling the unit, activating a software client, registering a product unit with the product source for customer support and product monitoring. The embodiment described with reference to FIG. 5 assumes that the product source sells products directly to a VAR and that the VAR is responsible to notifying a customer of the POC associated with them.

As described earlier with reference to FIG. 1, the source site 11 is typically associated with the manufacture and initial point of sale of a product unit, which in the preferred embodiment is a mobile robotic device. Each of the transactions between the three sites are represented in FIG. 5 by directional lines labeled with associated transaction numbers included in circles. In transaction 1, the source site 11 makes an initial sale of product to the VAR 12 and ships one or more units to the VAR 12. If this is the first sale of product to the VAR, the source site 11 assigns a product origination code (POC) to the VAR 12 which uniquely identifies this VAR 12 to which units of the product are sold. The source site 11 can also assign a serial number to the unit(s) it sells to the VAR which uniquely distinguishes the unit(s) from all other units sold by the source site 11. The serial number can be electronically embedded into some memory device included with the unit. Typically, the POC is assigned when the source site 11 and the VAR site 12 agree to a seller/reseller reseller relationship. In transaction 2, the VAR 12 can sell one or more product units to a customer 13. At the time the VAR sells a product unit to the customer, the VAR notifies the customer of their POC. After receiving the POC from the VAR, the customer in transaction 3 can send a request to the source 11 to activate a software client to run on their control device, such as the control device 19. This software client activation procedure can be initiated by the customer by accessing a web page at the source site 11. The source site web page can include instructions for the customer to enter the POC that was provided to them by the VAR in transaction 2. In transaction 4, the source 11 recognizes the POC as being a valid POC and responds to the customer request by sending a digital certificate that can be saved on the customer control device 19 and is associated with the software client running on the control device. In transaction 5, the customer can send a request to the source 11 to register a product unit sold to it by the VAR 12. This request to register a product unit can also include a request by the customer to be granted permission to access their product operational information stored at the source site 11. The source 11, after receiving the customer's request, uses the DBMS 16 to configure a customer product operational file, that can be dedicated to the product unit for which the customer is requesting registration, and the source 11 can grant or not grant the customer permission to access their product information files. In operation, the Service 17 located at the source site server 15 can operate to periodically initiate a communication session with the mobile robotic device 18 to examine/query the operational status of the device which can be stored in hardware registers (such as the status monitor 45) in the device or in other stored means such as dynamic or static memory. This information is then returned, with the device serial number, to the source site 11 server 15 where the DBMS 16 stores it in the database 26 according to the POC. In this manner a historical log of robotic device status can be examined by either the source site 11, the customer 13, and/or the VAR site 12 and the information included in the log can be used to determine if any service activity is necessary or it can be used for marketing purposes.

It should be understood, that a request to register more than one product unit can be sent by the customer to the source and the Service 17 at the source can instruct the DBMS to create a separate file dedicated to each of the units for which registration is being requested. In transaction 6, the VAR can send a request to the source 11 to be permitted to access some or all of the customer product operational information stored at the source site 11 corresponding to customers the VAR has sold product to. In transaction 7, the source can grant or not grant the VAR permission to access the customer's product operation information store. In transaction 8, the source 11 can gather product operational information from the customer's product unit and store this information in a corresponding file in storage 16.

The source site 11 can organize the customer product information files so that customer information associated with the resale of product units sold by a VAR, and which the VAR is permitted to access, occupies a particular file or record which is identified in the database by at least the POC. Other files or records containing status information associated with a customer's unit to which the VAR is not permitted access can also be stored in the database. In this manner, information gathered about the sale and certain operational characteristics of the unit to which the VAR is permitted access is stored in one customer record and other information gathered from the unit, such as call and use records, for instance, to which the VAR is not permitted access are stored separate database records. files, to which the VAR may not be permitted access, generally can include the status of units, such as unit battery levels, whether the unit is currently on or off-line, a log of call information, whether the unit is currently available to enter into a call or not available, the wireless signal connectivity strength and the version of software currently loaded into the unit, to name only a few.

FIG. 6 illustrates an alternative embodiment in which the source site 11 notifies a customer of the POC that they can use to activate their software client, and in which the VAR may or may not sell the product directly to the customer. In transaction 1A, the VAR 12 sells and ships one or more product units directly to a customer 13 and notifies the customer of the POC associated with the VAR if the customer has not already been so notified. Alternatively, in transaction 1B, the source 11 sells and ships one or more product units directly to a customer 13 and notifies the customer of the product source POC if the customer has not already been so notified. In transaction 2, the VAR 12 notifies the source 11 of the product sales to customer 13 and that the customer has been notified of their POC. In transaction 3, the customer 13 sends a request to the source 11 to activate the software client 40 and includes the POC with the request. In transaction 4, the source verifies the POC in the customer request and responds by issuing a digital certificate (public key) that is associated with the customer software client. Customer 13 is now recognized by the Service 17 as a trusted customer. In transaction 5, the customer 13 sends a request to the source 11 to register one or more product units. The request is comprised of the identities of one or more product units and the digital certificate issued previously by the source 11. The source 11 receives the request and the Service 17 operates to create a file in which to store the customers product operational information corresponding with at least one of the product units which are the subject of the request. In transaction 6, the Service 17 can operate to gather product operational information from one or more of the customer's 13 product units and store the operational information in a file created for this purpose.

Continuing to refer to FIG. 6, and according to another embodiment, in transaction 1A, it is not necessary that the VAR 12 notify the customer 13 of the POC associated with the VAR 12. Alternatively, the source 11 can notify the customer 13 of the VAR's POC directly. Ultimately, it is not important whether the source or the VAR notifies the customer of the POC, but it is important that the customer is notified of the POC, otherwise they will not be able to activate their software client which is need to register the products purchased from either the VAR or from the source.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

I claim:

1. A method for configuring a remote product management service, comprising:
assigning a unique product origination code to the source of a product;
selling one or more product units to a customer and notifying the customer of the product origination code;
initializing a customer software client using the product origination code;
the remote product management service receiving a request from the software client to register one or more product units with the service; and
using information included in the request, received from the software client by the remote product management service, to configure a data base file that is identified by at least the product origination code and which is used to store a record of product operational information associated with the one or more product units registered with the service.

2. The method of claim 1, wherein the source of the product is the site responsible for the initial sale of the product.

3. The method of claim 2, wherein the site responsible for the initial sale of the product is the manufacturer.

4. The method of claim 1, wherein the customer is notified of the product origination code by the source of the product.

5. The method of claim 4, wherein the source of the product can be the product source or an intermediary.

6. The method of claim 1, wherein initializing the customer software client comprises sending a request to the remote product management service that includes the product origination code.

7. The method of claim 1, wherein subsequent to initializing the customer software client, it becomes a trusted customer software client.

8. The method of claim 7, wherein one or both of the trusted customer software client and intermediary is granted permission by the remote product management service to access product operational information stored in the data base file associated with the registered product unit.

9. The method of claim 8, wherein the permission granted by the remote product management service comprises one of two or more levels of permissions.

10. The method of claim 1, wherein the information in the product registration request is comprised of a unique product unit identity.

11. The method of claim 11, wherein the unique product unit identity is a unit serial number.

12. The method of claim 1, further comprising the remote product management service receiving operational information from the registered customer product and storing the information in the data base file configured for the registered product unit.

13. A remote product management system, comprising:
a wide area network;
a customer site connected to the wide area network, the customer site comprising a trusted software client used to control the operation of a product unit and to request registration of the product unit with a remote product management service; and
a source site connected to the wide area network, the source site comprising the remote product management service that operates to receive a request from the trusted customer software client to register the product unit and to use information in the request to configure a data base file used to store a record of operational information associated with the product unit for which registration is requested.

14. The remote product management system of claim 13, wherein the wide area network is the Internet.

15. The remote product management system of claim 13, wherein the trusted customer software client comprises a public key assigned to it by the source site.

16. The remote product management system of claim 13, wherein the product unit is a mobile robotic device.

17. The remote product management system of claim 13, wherein the operation of the product unit controlled by the trusted software client is comprised of one or more of motion control and audio and video communication session control.

18. The remote product management system of claim 13, wherein the product unit registration request is comprised of a unique product unit identity.

19. The remote product management system of claim 18, wherein the unique product unit identity is a unit serial number.

20. The remote product management system of claim 13, wherein the remote product management service comprises:
means for gathering customer product operational information;
means for granting permission to access customer product operational information;
means for updating customer product software; and
means for managing the data base files configured to store the record of operational information associated with the product unit.

21. The remote product management system of claim 13, further comprising the source site periodically receiving customer product operational information for customer product units and storing the information in the data base file associated with the product unit.
